(19) United States
(12) Patent Application Publication
(10) Pub. No.: US 2026/0019479 A1
(43) Pub. Date: Jan. 15, 2026

(54) DATA PACKET GENERATION APPARATUS, METHOD, AND PROGRAM PRODUCT

(71) Applicants: DENSO CORPORATION, Kariya-city, Aichi-pref. (JP); TOYOTA JIDOSHA KABUSHIKI KAISHA, Toyota-shi, Aichi-ken (JP); J-QuAD DYNAMICS Inc., Chuo-ku, Tokyo (JP)

(72) Inventors: Minoru YOKOTA, Tokyo (JP); Satoshi HORIHATA, Kariya-city (JP); Hiroki FUKATSU, Tokyo (JP)

(21) Appl. No.: 19/256,680

(22) Filed: Jul. 1, 2025

(30) Foreign Application Priority Data
Jul. 3, 2024 (JP) 2024-107379

(51) Int. Cl. H04L 69/325; H04L 47/36

(52) U.S. Cl. CPC H04L 69/325; H04L 47/36; H04L 2212/00

(57) ABSTRACT

In a data packet generation apparatus, a packet generator encapsulates, in response to determination that at least one dynamic data item included in the surrounding environmental data acquired in each sequence cannot be encapsulated in a corresponding data packet as at least one remaining dynamic data item, the at least one remaining dynamic data item in one of the data packets generated for the subsequent sequences. The packet generator discards, in response to determination that at least one static data item included in the surrounding environmental data acquired in the corresponding sequence cannot be encapsulated in the corresponding data packet as at least one remaining static data item, the at least one remaining static data item.

### REFERENCE TO RELATED APPLICATIONS

This application is based on and claims the benefit of priority from Japanese Patent Application No. 2024-107379 filed on Jul. 3, 2024, the disclosure of which is incorporated in its entirety herein by reference.

### TECHNICAL FIELD

The present disclosure relates to data packet generation apparatuses, data packet generation methods, and computer program products.

### BACKGROUND

Known technologies transmit, to a server, information acquired by sensors, such as cameras installed in a vehicle, as data packets. Japanese Patent Application Publication NO. 2023-125484 discloses such a data transmission system. The system is configured such that a device installed in a vehicle, which is comprised of a drive recorder, uploads, to a management system, vehicle-related information on the vehicle. The vehicle-related information includes, for example, captured images and positional information on the vehicle, the speed information on the vehicle, and steering information on the vehicle.

To reduce communication traffic between the in-vehicle device and the management system, the system disclosed in the patent publication is configured to upload, to the management system, low-volume data, such as still images, extracted from the vehicle-related information, every predetermined period, and upload, in response to receiving a transmission request sent from the management system, data that is included in the vehicle-related information, the specified data and is specified by the transmission request.

### SUMMARY

Let us assume a situation where the system disclosed in the patent publication encapsulates the data specified by the transmission request into a predetermined-sized data packet in order to upload the data specified by the transmission request to the management system.

In this situation, if the data to be uploaded to the management system is large-volume data, the system disclosed in the patent publication may have difficulty uploading the data as a single data packet, resulting in data, which cannot be uploaded, remaining. Unfortunately, the patent publication may not address such a situation where data cannot be completely uploaded to the management system.

The inventors of the present disclosure have figured out that measurement data acquired by sensors installed in a vehicle, which represent the surrounding environment around the vehicle, may include various types of data. For example, the various types of data may include (I) a first type of data that should be transmitted to the management system without being deleted as long as possible even if transmission of the first type of data is delayed, and (II) a second type of data that can be deleted because the second type of data can be substituted by data transmitted from, for example, other vehicles.

That is, packetization of these various types of data may have room for further improvement.

An exemplary aspect of the present disclosure provides a data packet generation apparatus for a vehicle. The data packet generation apparatus includes a data acquisition unit configured to acquire, in each of sequences, surrounding environmental data recognized based on one or more measurements from at least one sensor installed in the vehicle. The surrounding environmental data represents a surrounding environment around the vehicle. The surrounding environmental data acquired in each sequence including at least one of one or more dynamic data items that are changeable over time, and one or more static data items that do not change over time. The data packet generation apparatus includes a packet generator configured to generate, for each sequence, a data packet based on at least the surrounding environmental data acquired in the corresponding sequence. The data packet has a predetermined data size.

The packet generator is configured to determine, for each sequence, whether all the one or more dynamic data items included in the surrounding environmental data acquired in the corresponding sequence can be encapsulated in the corresponding data packet. The packet generator is configured to encapsulate, in response to determination that at least one dynamic data item included in the surrounding environmental data acquired in the corresponding sequence cannot be encapsulated in the corresponding data packet as at least one remaining dynamic data item, the at least one remaining dynamic data item in one of the data packets generated for the subsequent sequences. The packet generator is configured to determine, for each sequence, whether all the one or more static data items included in the surrounding environmental data acquired in the corresponding sequence can be encapsulated in the corresponding data packet. The packet generator is configured to discard, in response to determination that at least one static data item included in the surrounding environmental data acquired in the corresponding sequence cannot be encapsulated in the corresponding data packet as at least one remaining static data item, the at least one remaining static data item.

In response to determination that at least one dynamic data item included in the surrounding environmental data acquired in the corresponding sequence cannot be encapsulated in the corresponding data packet as at least one remaining dynamic data item, the data packet generation apparatus encapsulates the at least one remaining dynamic data item in one of the data packets generated for the subsequent sequences. This avoids the occurrence of situations where dynamic data items acquired by the vehicle, which change over time and are likely not to be acquired from another vehicle, are not transmitted from the vehicle.

Additionally, in response to determination that at least one static data item included in the surrounding environmental data acquired in the corresponding sequence cannot be encapsulated in the corresponding data packet as at least one remaining static data item, the data packet generation apparatus discards the at least one remaining static data item.

This avoids the delay of transmission of dynamic data items due to static data items remaining in each data packet. Additionally, even if such remaining static data items acquired in the vehicle, which cannot be encapsulated in a data packet, are discarded, similar static data items are likely to be acquired in another vehicle. For this reason, the data packet generation apparatus according to the exemplary embodiment makes it possible to reduce the impact caused by discarding static data items, as compared with discarding dynamic data items.

### BRIEF DESCRIPTION OF THE DRAWINGS

The above object, other objects, characteristics, and advantageous benefits of the present disclosure will become apparent from the following description with reference to the accompanying drawings in which:

FIG. 1 is a block diagram illustrating a schematic configuration of an information collecting system that includes in-vehicle devices to each of which a data packet generation apparatus according to an exemplary embodiment of the present disclosure has been applied;

FIG. 2 is a front view schematically illustrating an example of the configuration of a traffic light;

FIG. 3 is a flowchart schematically illustrating a data packet generation routine according to the exemplary embodiment;

FIG. 4 is a flowchart schematically illustrating the data packet generation routine according to the exemplary embodiment; and

FIG. 5 is a diagram schematically illustrating how the data packet generation routine generates data packets.

### DETAILED DESCRIPTION OF EMBODIMENT

The following describes an exemplary embodiment and its modifications of the present disclosure with reference to accompanying drawings.

### Exemplary Embodiment

### System Configuration

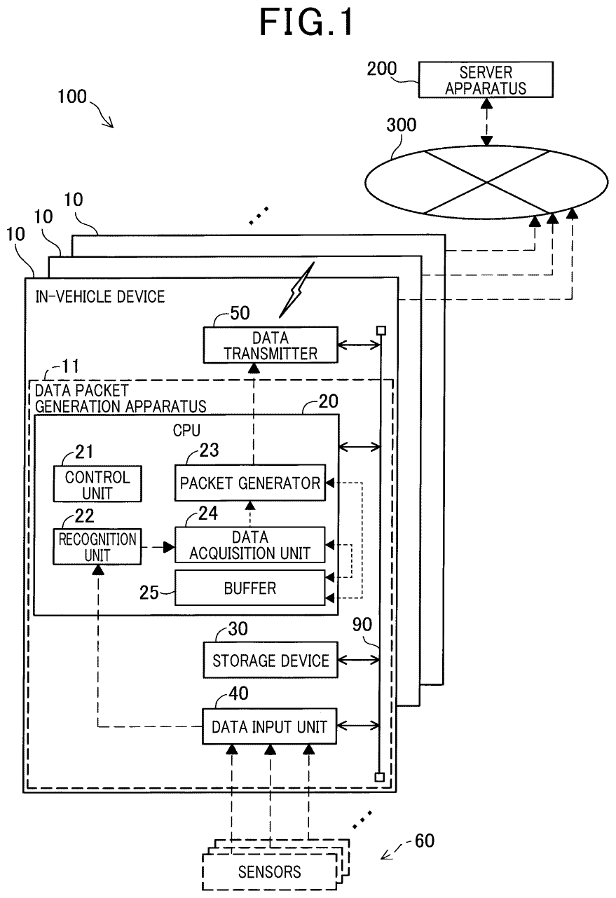

An information collecting system 100 illustrated in FIG. 1 includes (i) a plurality of in-vehicle devices 10 installed in a plurality of respective unillustrated vehicles, and (ii) a server system 200 that is communicably connected to the in-vehicle devices 10 through a network 300.

In the information collecting system 100, each in-vehicle device 10 is configured to transmit surrounding environmental data around the corresponding vehicle acquired thereby to the server system 200 through the network 300, and the server system 200 is configured to collect the surrounding environmental data uploaded from each in-vehicle device 10. Transmitting data from each in-vehicular device 10 to the server system 200 will also be referred to as uploading data therefrom.

The surrounding environmental data around a vehicle means data indicative of a surrounding environment around the vehicle, which can be recognized from measurements from sensors 60 installed in the vehicle. The server system 200 is configured to store the surrounding environmental data collected from each of the in-vehicle devices 10, and generate, based on the stored surrounding environmental data items, three-dimensional map data. For example, the three-dimensional map data includes
(I) Three-dimensional road position information items, each of which represents the longitudinal and latitudinal coordinates of a corresponding one of sections of a corresponding one of roads,
(II) Three-dimensional natural/artificial feature position information items, each of which represents the three-dimensional longitudinal and latitudinal coordinates of a corresponding one of natural/artificial features, such as buildings or guardrails, on or around the roads,
(III) Road-related information items, each of which is related to the corresponding one of the roads, and

(IV) Timestamp information items, i.e., Year/month/day/time information items, each of which represents the year, month, day, and time that the corresponding one of the information items (I), (II), and (III) was updated

The server system 200 is configured to transmit, i.e., download, the generated three-dimensional map data to each in-vehicle device 10 of the corresponding vehicle. Each in-vehicle device 10 can be configured to perform driving-assistance control operations of the corresponding vehicle using the downloaded three-dimensional map data. Detailed information on the surrounding environmental data around each vehicle will be described later.

The server system 200 is comprised of, for example, one or more computers installed in a data center. The network 300 includes, for example, a communication network, such as a Wide Area Network (WAN) provided by, for example, a telecommunications carrier, a wireless local-area network (LAN), and/or a wired LAN.

Each in-vehicle device 10 includes a data-packet generating apparatus 11 and a data transmitter 50.

The data-packet generating apparatus 11 is configured to generate data packets based on the surrounding environmental data acquired thereby.

The data transmitter 50 of each in-vehicle device 10 is configured to transmit, i.e., update, the data packets to the server system 200 through the network 300. The data transmitter 50 of each in-vehicle device 10 is configured to perform mobile communication, such as 4G (Fourth Generation Communication) or 5G (Fifth Generation Communication) to accordingly update the surrounding environmental data from the current position of the corresponding vehicle to the server system 200.

The data-packet generating apparatus 11 of each in-vehicle device 10 is configured to receive measurements from the sensors 60 installed in the corresponding vehicle, and identify or recognize, based on the measurements, surrounding environmental data around the corresponding vehicle. Then, the data-packet generating apparatus 11 of each in-vehicle device 10 is configured to generate one or more data packets that include the surrounding environmental data, and transfer the data packets to the data transmitter 50.

The sensors 60 of each vehicle are each configured to measure information related to the surrounding environment around the corresponding vehicle. The sensors 60 include, for example, various types of sensors, such as one or more imaging cameras, one or more millimeter-wave radars, one or more sonars, one or more Light Detection and Ranging (Lidar) sensors, and a position detection sensor. The position detection sensor includes, for example, a global navigation satellite system (GNSS) receiver, such as a global positioning system (GPS) receiver, which is configured to receive GPS signals, which are sent from GPS satellites, and identify, based on the received GPS signals, the current position of the corresponding vehicle.

Each image captured by the at least one camera is comprised of two-dimensionally arranged pixels, i.e., light-intensity values or pixel values, corresponding to a two-dimensionally arranged light-sensitive elements of an image sensor of the at least one camera.

The data-packet generating apparatus 11 of each in-vehicle device 10 includes a CPU 20, a storage device 30, and a data input unit 40. The data transmitter 50, the CPU 20, the storage device 30, and the data input unit 40 are configured to communicate data with one another through an internal bus 90.

The storage device 30 is comprised of, for example, one or more read-only memories (ROMs) and one or more random access memories (RAMs). The storage device 30 stores computer programs, i.e., computer-program instructions, that cause the CPU 20 to serve as a controller of the data-packet generating apparatus 11. The CPU 20 is configured to execute the computer-program instructions to serve as a control unit 21, a recognition unit 22, a packet generator 23, and a data acquisition unit 24.

The control unit 21 is configured to control the overall operations of the data-packet generating apparatus 11.

The recognition unit 22 is configured to recognize the surrounding environment around the corresponding vehicle based on the measurements from the sensors 60 inputted thereto through the data input unit 40.

The term “surrounding environment” around a vehicle refers to various types of features existing around the vehicle, which may be used for generating a three-dimensional map or for assisting the driving of the vehicle.

The features existing around a vehicle include, for example, signboards, traffic lights, and traffic signs located around the road on which the vehicle is traveling, which will be referred to as a “traveling road”. The features existing around a vehicle also include road markers drawn on the surface of the traveling road, such as stop lines, pedestrian crossings, arrow markings, lane markings, and indicators of a pedestrian crossing ahead. The features existing around a vehicle further include, for example, illumination information on at least one traffic light, obstacles such as pylons, and poles installed in road shoulders.

The surrounding environmental data includes dynamic dada items that can change over time, and static data items that do not change over time.

Each of the dynamic data items according to the exemplary embodiment includes for example the illumination information on at least one traffic light. The illumination information on at least one traffic light shows which of the lighting sections of the at least one traffic light is illuminated. Each of the lighting sections of the at least one traffic light means a portion of the at least one traffic light that illuminates. Each of the lighting sections is comprised of, for example, a lamp, a lens, and a hood enclosing the lamp and the lens, and is configured to emit, through the lens, light generated from the lamp.

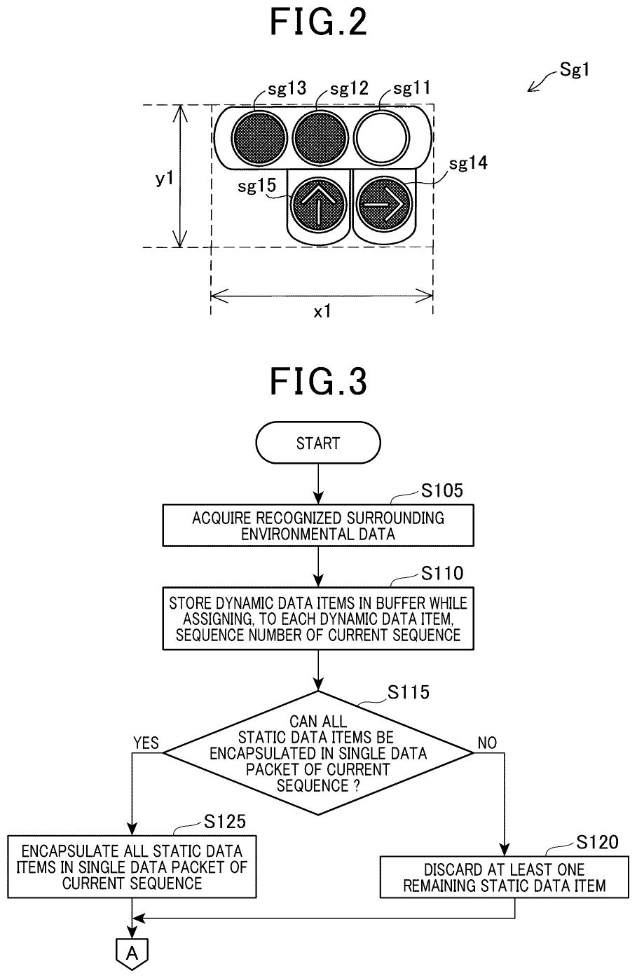

FIG. 2 illustrates an example of a traffic light Sg1 provided for a road.

The traffic light Sg1 has a main housing H1 that has a substantially rectangular-parallelepiped shape and two auxiliary housings H2 and H3, each of which has a substantially rectangular-parallelepiped shape. The main box housing H1 is located above the road while the longitudinal direction extends in parallel to the width direction of the road. Each of the two auxiliary housings H2 and H3 is mounted on the bottom of the main housing H1 while extending therefrom toward the road.

The traffic light Sg1, i.e., the main housing H1 thereof, has a predetermined lateral width x1. Similarly, the traffic light Sg1 has a predetermined vertical width y1 defined as a length from the top of the main housing H1 to the bottom of each auxiliary housing H2.

The traffic light sg1 includes three main lighting sections sg11, sg12, and sg13 installed in the main housing H1, and two auxiliary lighting sections sg14 and sg15 installed in the respective auxiliary housings H2.

The main lighting section sg11 can be illuminated in red, the main lighting section sg12 can be illuminated in yellow, and the main lighting section sg13 can be illuminated in blue or green. The auxiliary lighting section sg14 can be illuminated in the shape of a rightward arrow, and the auxiliary lighting section sg15 can be illuminated in the shape of an upward arrow that indicates “go straight”.

For example, the illumination status of the lighting sections sg11 to sg15 illustrated in FIG. 2 shows that the main lighting section sg11 is illuminated in red, the auxiliary lighting section sg14 illustrated in FIG. 2 is luminated in the shape of the rightward arrow, and the auxiliary lighting section sg15 illustrated in FIG. 2 is illuminated in the shape of the upward arrow, i.e., the straight-ahead arrow. That is, the illumination status of the lighting sections sg11 to sg15 illustrated in FIG. 2 shows that straight-ahead vehicles and right-turning vehicles are allowed to go forward.

The illumination information on at least one traffic light according to the exemplary embodiment includes, for example, (i) the type of lighting of at least one of the lighting sections that is illuminated, (ii) the identification (ID) of the at least one traffic light, and (iii) the positional information on the at least one traffic light. The type of lighting of at least one of the lighting sections that is illuminated, the ID of the at least one traffic light, and the positional information on the at least one traffic light are handled as a dynamic data item according to the exemplary embodiment. To all traffic lights, which can be represented in the three-dimensional map data, predetermined identifications have been already assigned as their IDs.

Specifically, the positional information on each of the traffic lights and the ID of the corresponding one of the traffic lights are stored beforehand as traffic-light information in the storage device 30 while the positional information on each of the traffic lights correlates with the ID of the corresponding one of the traffic lights.

The recognition unit 22 of each in-vehicle device 10 is configured to determine, based on the measurements acquired by the sensors 60, whether at least one traffic light is located in the direction of travel of the corresponding vehicle. When determining that the at least one traffic light is located in the direction of travel of the corresponding vehicle, the recognition unit 22 of each in-vehicle device 10 is configured to recognize the at least one traffic light, and refer to (i) the current position of the corresponding vehicle measured by, for example, the GNSS receiver and (ii) the three-dimensional map stored in the corresponding in-vehicle device 10 to accordingly identify the position of the at least one traffic light. Then, the recognition unit 22 of each in-vehicle device 10 is configured to refer to the traffic-light information stored in the storage device 30 to accordingly identify the ID of the at least one traffic light.

The recognition unit 22 of each in-vehicle device 10 is configured to obtain, based on, for example, the pixels of one or more images captured by the at least one camera, how the recognized traffic light illuminates.

In a case where the illumination status of the lighting sections sg11 to sg15 is illustrated in FIG. 2, the recognition unit 22 can generate, based on the measurements from the sensors 60, the following first to third dynamic data items:

The first dynamic data item (I) including the ID of the traffic light Sg1, the positional information on the traffic light Sg1, and the traffic light Sg1 indicating red light.

The second dynamic data item (II) including the ID of the traffic light Sg1, the positional information on the traffic light Sg1, and the traffic light Sg1 indicating the rightward arrow.

The third dynamic data item (III) including the ID of the traffic light Sg1, the positional information on the traffic light Sg1, and the traffic light Sg1 indicating the straight-ahead arrow.

That is, the illumination information on the traffic light Sg1 includes the ID of the traffic light Sg1 and the positional information on the traffic light Sg1. For this reason, even if the server apparatus 200 acquires a part of the first to third dynamic data items of the traffic light Sg1 at a timing different from the timing at which the server apparatus 200 acquires the remaining of the first to third dynamic data items of the traffic light Sg1, the server apparatus 200 can be configured to identify the number of the lighting sections of the traffic light Sg1 and the color of each lighting section of the traffic light Sg1.

Each of the static data items according to the exemplary embodiment includes, for example, size data indicative of the size of at least one traffic light. For example, when detecting the traffic light Sg1 illustrated in FIG. 2, the recognition unit 22 recognizes the lateral width x1 and the vertical width y1 of the traffic light Sg1 as the size data of the traffic light Sg1. That is, when detecting the traffic light Sg1 illustrated in FIG. 2, the recognition unit 22 recognizes a static data item of the traffic light Sg1 including the ID, the positional information, the lateral width x1, and the vertical width y1 of the traffic light Sg1.

The recognition unit 22 of each in-vehicle device 10 can use one of known recognition methods. For example, the recognition unit 22 of each in-vehicle device 10 can recognize the surrounding environment around the corresponding vehicle using a known recognition method based on Convolution Neural Networks (CNN), You Only Look Once (YOLO), and/or Single Shot Multi-Box Detector (SSD). Alternatively, many patterns of each of natural/artificial features on or around roads can be stored in the storage device 30, and the recognition unit 22 of each in-vehicle device 10 can perform known pattern matching of the measurements from the sensors 60, such as the measured images of the at least one camera, with the patterns stored in the storage device 30 to accordingly recognize the surrounding environment around the corresponding vehicle.

The packet generator 23 of each in-vehicle device 10 illustrated in FIG. 1 is configured to sequentially generate data packets, each of which has a predetermined data size or data amount. For example, the data size of each data packet that the packet generator 23 of the exemplary embodiment generates is set to, for example, 900 bytes, but each data packet can have any data size.

The packet generator 23 of each in-vehicle device 10 according to the exemplary embodiment is configured to generate data packets at regular intervals. Specifically, the packet generator 23 of each in-vehicle device 10 according to the exemplary embodiment is configured to generate a single data packet with a data size of 900 bytes every 100 milliseconds. The packet generator 23 of each in-vehicle device 10 according to the exemplary embodiment can be configured to generate a single data packet at arbitrary time intervals.

The packet generator 23 of each in-vehicle device 10 is configured to transmit, to the data transmitter 50, each of the generated data packets.

The data acquisition unit 24 of each in-vehicle device 10 is configured to sequentially acquire the surrounding environmental data recognized by the recognition unit 22 of the corresponding in-vehicle device 10. The data acquisition unit 24 of each in-vehicle device 10 is configured to acquire surrounding environmental data from the recognition unit 22 at regular intervals. Specifically, the data acquisition unit 24 of each in-vehicle device 10 is configured to acquire surrounding environmental data item from the recognition unit 22 every 100 milliseconds. The data size of each surrounding environmental data that the data acquisition unit 24 acquires can vary depending on the recognition results of the recognition unit 22. For this reason, the data size of surrounding environmental data acquired by the data acquisition unit 24 from the recognition unit 22 at one time can be lower than 900 bytes or higher than or equal to 900 bytes.

The CPU 20 of each in-vehicle device 10 includes a buffer 25. The buffer 25 is designed as a FIFO (First In, First Out) buffer. The buffer 25 is configured such that data items are stored therein and then retrieved therefrom in the same order in which they were stored therein.

Specifically, the data acquisition unit 24 is configured to store, in the buffer 25, dynamic data items included in the surrounding environmental data acquired from the recognition unit 22 in a predetermined order in which the dynamic data items are acquired, and retrieve them in the same order. The buffer 25 can be configured as a part of the storage region of the storage device 30 or as an additional storage.

The acquisition of surrounding environmental data by the data acquisition unit 24, the storage of dynamic data items included in the surrounding environmental data by the data acquisition unit 24 in the buffer 25, and the generation of a data packet by the packet generator 23 are for example executed every 100 milliseconds as a synchronized sequence.

The data input unit 40 of each in-vehicle device 10 is configured to receive the measurements from the sensors 60. For example, the data input unit 40 of each in-vehicle device 10 is configured to communicate with the sensors 60 through an unillustrated Control Area Network (CAN) to retrieve, from the sensors 60, the measurements from the sensors 60. Alternatively, the data input unit 40 of each in-vehicle device 10 is configured to retrieve, from the sensors 60, the measurements from the sensors 60 through a dedicated communication line provided separately from the CAN.

The data packet generating apparatus 11 of each in-vehicle device 10 included in the information collecting system 100 is configured to perform a data packet generation routine described later. The data packet generation routine is programmed to encapsulate the surrounding environmental data acquired by the recognition unit 22 into data packets. In particular, even if it is difficult to encapsulate a part of the surrounding environmental data in a regularly generated data packet due to the large size of the surrounding environmental data, the data packet generation routine makes it possible to efficiently generate data packets.

The following describes the data packet generation routine.

### Data Packet Generation Routine

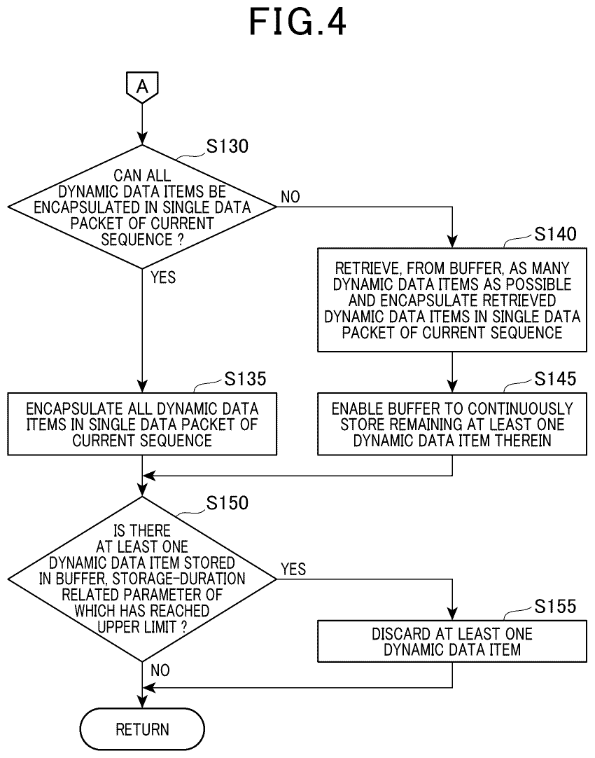

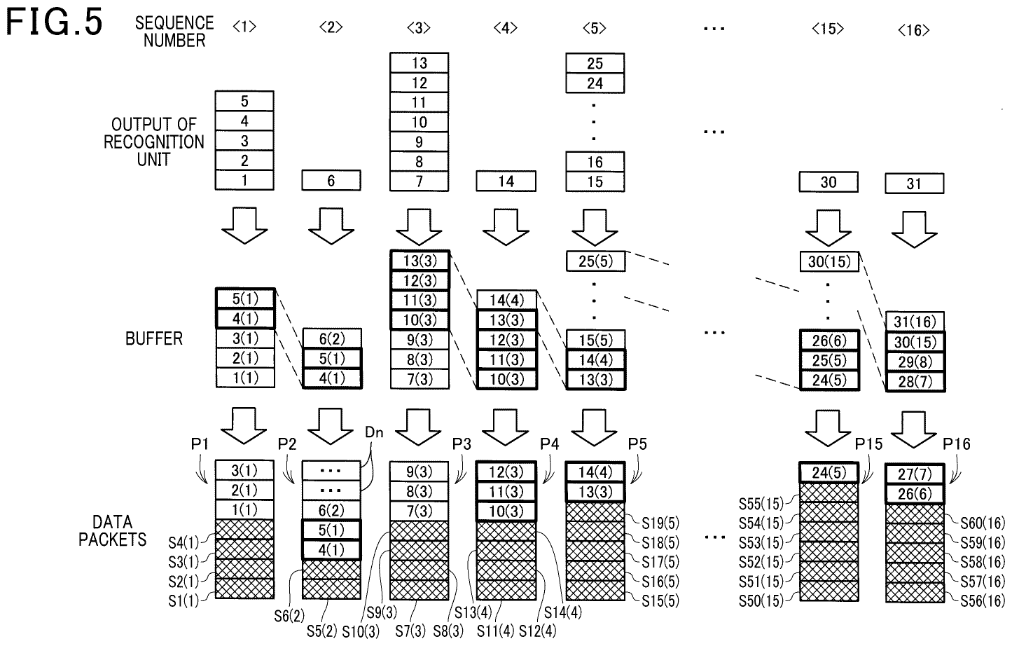

The CPU 20 of the data packet generating apparatus 11 of each in-vehicle device 10 is programmed to execute the data packet generation routine illustrated in FIGS. 3 and 4 in response to the corresponding in-vehicle device 10 being powered on. While each in-vehicle device 10 is powered on, each of the sensors 60 of the corresponding vehicle is activated to continuously measure information related to the surrounding environment around the corresponding vehicle, and recognition unit 22 of the corresponding in-vehicle device 10 is configured to continuously recognize the surrounding environment around the corresponding vehicle based on the measurements from the sensors 60. The data packet generation routine is comprised of operations in steps S105 to S155. That is, the CPU 20 of the data packet generating apparatus 11 of each in-vehicle device 10 is programmed to iteratively execute the data packet generation routine as a sequence of the operations in steps S105 to S105 every predetermined period.

When starting the data packet generation routine, which will be referred to simply as a routine, the CPU 20 serves as, for example, the data acquisition unit 24 to retrieve, from the recognition unit 22, the surrounding environmental data recognized thereby in step S105. The surrounding environmental data includes static data items and dynamic data items.

Next, the CPU 20 serves as, for example, the data acquisition unit 24 to store the dynamic data items in the buffer 25 while assigning, to each of the dynamic data items, a sequence number of the currently executing routine, i.e., the currently executing sequence, in step S110. That is, the sequence number of the first routine, i.e., the first sequence, executed by the CPU 20 is 1, and the sequence number of the kth routine (k is an integer more than or equal to 2), i.e., the kth sequence, executed by the CPU 20 is k.

For example, if the illumination status of the lighting sections sg11 to sg15 of the traffic light Sg1 illustrated in FIG. 2 is recognized by the recognition unit 22 and the first to third dynamic data items (I) to (III) are retrieved in step S105 of the first sequence, the CPU 20 serves as the data acquisition unit 24 to assign, to each of the first to third dynamic data items (I) to (III), the sequence number “1”, and thereafter store the first to third dynamic data items (I) to (III) in the buffer 25 serving as a FIFO buffer.

Following the operation in step S110, the CPU 20 serves as, for example, the packet generator 23 to determine whether all the static data items included in the surrounding environmental data retrieved in step S105 of the currently executing sequence can be fully encapsulated in a single data packet in step S115. In other words, the CPU 20 serves as, for example, the packet generator 23 to determine whether all the static data items included in the surrounding environmental data retrieved in step S105 of the currently executing sequence are capable of being fully encapsulated in a single data packet in step S115.

In particular, the CPU 20 serves as, for example, the packet generator 23 to generate, based on the surrounding environmental data acquired in step S105, one or more data packets in accordance with predetermined priority levels previously assigned to respective items of the surrounding environmental data acquired in step S105. Specifically, the priority levels of the dynamic data items, each of which is related to the illumination information on at least one traffic light, are set to be lower than the priority levels of the static data items of the features, such as the signboards or traffic lights, existing around the corresponding vehicle.

Specifically, the CPU 20 serves as, for example, the packet generator 23 to encapsulate the items of the surrounding environmental data in a single data packet in accordance with the priority levels of the items of the surrounding environmental data.

More specifically, the CPU 20 serves as, for example, the packet generator 23 to determine whether the sum of the data sizes of all the static data items included in the surrounding environmental data is greater than the data size of, for example, 900 bytes, of a single data packet in step S115.

In response to determination that the sum of the data sizes of all the static data items included in the surrounding environmental data is greater than the data size of a single data packet, the CPU 20 serves as, for example, the packet generator 23 to determine that all the static data items included in the surrounding environmental data cannot be fully encapsulated in a single data packet (NO in step S115). Then, the CPU 20 serves as, for example, the packet generator 23 to encapsulate the static data items in a single data packet in order of the priority levels of the static data items, starting from the highest to the lowest in step S120. This results in at least one static data item included in the surrounding environmental data remaining without being stored in the single data packet.

In step S120, the CPU 20 serves as, for example, the packet generator 23 to discard the at least one remaining static data item, which cannot be stored in the single data packet.

Specifically, the data packet generator 23 encapsulates the static data items in a single data packet in order of the priority levels of the static data items, and in response to determination that one or more static data items with relatively low priority levels remain when the stored data size has reached 900 bytes that is the data size of the single data packet, the packet generator 23 discards the remaining one or more static data items in step S120.

Otherwise, in response to determination that the sum of the data sizes of all the static data items included in the surrounding environmental data is smaller than or equal to the data size of a single data packet, the CPU 20 serves as, for example, the packet generator 23 to determine that all the static data items included in the surrounding environmental data can be fully encapsulated in a single data packet (YES in step S115). Then, the CPU 20 serves as, for example, the packet generator 23 to encapsulate all the static data items in a single data packet in order of the priority levels of the static data items, starting from the highest to the lowest in step S125.

After completion of the operation in step S120 or the operation in step S125, the CPU 20 serves as, for example, the packet generator 23 to determine, as illustrated in FIG. 4, whether all the dynamic data items included in the surrounding environmental data and stored in the buffer 25 can be fully encapsulated in the target single data packet in which the static data items have been stored in step S130.

Note that, after completion of the operation in step S120 in which the remaining one or more static data items have been discarded, the current routine, i.e., the currently executing sequence, can proceed directly to the operation in step S145, because the data packet of the currently executing sequence is full of the static data items.

That is, if the total size of data items to be encapsulated in a data packet is smaller than or equal to the size of the available capacity of a data packet, it is determined that the data items can be encapsulated in the data packet. Otherwise, if the total size of data items to be encapsulated in a data packet is greater than the size of the available capacity of a data packet, it is determined that the data items can be encapsulated in the data packet.

Specifically, the CPU 20 serves as, for example, the packet generator 23 to determine whether the sum of the data sizes of all the dynamic data items included in the surrounding environmental data and stored in the buffer 25 is greater than the size of the available capacity of the target single tata packet in step S130. The available capacity of the target single tata packet can be calculated by subtracting, from the data size of, for example, 900 bytes, of the target single data packet, the data size of the static data items that have been stored in the target single data packet.

In response to determination that the sum of the data sizes of all the dynamic data items included in the surrounding environmental data and stored in the buffer 25 is greater than the size of the available capacity of the target single tata packet, the CPU 20 serves as, for example, the packet generator 23 to determine that all the dynamic data items stored in the buffer 25 and included in the surrounding environmental data cannot be fully encapsulated in the target single data packet (NO in step S130). Then, the CPU 20 serves as, for example, the packet generator 23 to retrieve, from the dynamic data items stored in the buffer 25, as many dynamic data items as possible; the retrieved dynamic data items can be encapsulated in the target single data packet in step S140. Then, the CPU 20 serves as, for example, the packet generator 23 to encapsulate the retrieved dynamic data items in the target single data packet in step S140. This results in at least one dynamic data item stored in the buffer 25 remaining without being stored in the single data packet.

Next, the CPU 20 serves as, for example, the packet generator 23 to control the buffer 25, enabling the buffer 25 to continuously store the remaining at least one dynamic data item therein in step S145.

Otherwise, in response to determination that the sum of the data sizes of all the dynamic data items included in the surrounding environmental data and stored in the buffer 25 is smaller than or equal to the size of the available capacity of the target single tata packet, the CPU 20 serves as, for example, the packet generator 23 to determine that all the dynamic data items stored in the buffer 25 can be fully encapsulated in the target single data packet (YES in step S130). Then, the CPU 20 serves as, for example, the packet generator 23 to encapsulate all the dynamic data items stored in the buffer 25 in the target single data packet in the predetermined order in which the dynamic data items are acquired in step S135.

After completion of the operation in step S135 or the operation in step S145, the CPU 20 serves as, for example, the data acquisition unit 24 to determine whether there is at least one dynamic data item stored in the buffer 25, a storage-duration related parameter of which has reached a predetermined upper limit in step S150. The storage-duration related parameter of any dynamic data item stored in the buffer 25 represents a parameter related to the duration or period for which the dynamic data item has been stored in the buffer 25. For example, the storage-duration related parameter of any dynamic data item stored in the buffer 25 according to the exemplary embodiment represents an absolute difference between the sequence number of the currently executing sequence and the sequence number assigned to the dynamic data item stored in the buffer 25. The upper limit according to the exemplary embodiment is set to “10”.

Specifically, the CPU 20 serves as, for example, the data acquisition unit 24 to determine whether there is at least one dynamic data item stored in the buffer 25; the absolute difference between the sequence number of the currently executing sequence and the sequence number assigned to the at least one dynamic data item stored in the buffer 25 has reached “10” in step S150.

In response to determination that there is at least one dynamic data item stored in the buffer 25, the storage-duration related parameter of which has reached the predetermined upper limit (YES in step S150), the CPU 20 serves as, for example, the data acquisition unit 24 to discard the at least one dynamic data item in step S155. Thereafter, the CPU 20 terminates the current executing sequence, and returns to step S105 of the next sequence. Otherwise, in response to determination that there are no dynamic data items stored in the buffer 25, the storage-duration related parameter of each of which has reached the predetermined upper limit (NO in step S150), the CPU 20 terminates the current executing sequence, and returns to step S105 of the next sequence.

The following describes how the data packet generation routine executed by the CPU 20 generates data packets with reference to FIG. 5. Hereinafter, the sequence, which has the sequence number N (N is an integer more than or equal to 1), will be referred to as the sequence N.

Additionally, each of the dynamic data items represents the illumination information on at least one traffic light, which includes (i) the type of lighting of at least one of the lighting sections that is illuminated, (ii) the ID of the at least one traffic light, and (iii) the positional information on the at least one traffic light. The dynamic data items are tagged with sequential numbers from 1, so that any dynamic data item can be represented as data n (n is an integer more than or equal to 1). A number in parentheses is assigned to each dynamic data item, i.e., each data n. The number in parentheses assigned to each dynamic data item represents the sequence number of the sequence in which the corresponding dynamic data item is acquired. For example, data 6(2) represents the dynamic data item 6 that is acquired in the sequence 2.

FIG. 5 illustrates that the sequence 1, the sequence 2, . . . , and the sequence 16 are carried out from the left to the right. The top area of FIG. 5 schematically shows the sequence numbers 1, 2, . . . , and 16. The second area of FIG. 5 schematically shows one or more dynamic data items outputted from the recognition unit 22 in each of the sequences. The third area of FIG. 5 schematically shows how one or more dynamic data items are stored in the buffer 25 in each of the sequences. The 20) fourth area, i.e., the bottom area, of FIG. 5 schematically shows a single data packet generated in each of the sequences. Additionally, in FIG. 5, each non-hatched rectangular block represents a corresponding dynamic data item, and each hatched rectangular blocks represents a corresponding static data item. FIG. 5 schematically illustrates an example where the data size of each single data packet is defined to store no more than seven static and/or dynamic data items in the corresponding single data packet.

In the sequence 1, five dynamic data items 1(1), 2(1), 3(1), 4(1), and 5(1) are acquired and outputted from the recognition unit 22. Note that four static data items S1(1), S2(1), S3(1), and S4(1) are also acquired and outputted from the recognition unit 22, but, in the second area of FIG. 5, the four static data items S1(1), S2(1), S3(1), and S4(1) are not illustrated.

In the sequence 1, the five dynamic data items 1(1), 2(1), 3(1), 4(1), and 5(1) are stored in the buffer 25, and the four static data items S1(1), S2(1), S3(1), and S4(1) are encapsulated in a data packet P1. Because the data packet P1 can store no more than seven data items, only three dynamic data items can be stored in the data packet P1. For this reason, the dynamic data items 1(1) to 3(1) are encapsulated in the data packet P1. The remaining two dynamic data items 4(1) and 5(1) stored in the buffer 25 are retained.

In the sequence 2, a new dynamic data item 6(2) is acquired and outputted from the recognition unit 22. Note that relatively few, for example, two, static data items S5(2) and S6(2) are also acquired and outputted from the recognition unit 22, but, in the second area of FIG. 5, the two static data items S5(2) and S6(2) are not illustrated.

In the sequence 2, the new dynamic data item 6(2) is stored in the buffer 25 in which the dynamic data items 4(1) and 5(1) have remained, and the two static data items S5(2) and S6(2) are encapsulated in a data packet P2 following the data packet P1. Because the data packet P2 can store no more than seven data items, the remaining dynamic data items 4(1) and 5(1) and the new dynamic data item 6(2) can be fully encapsulated in the data packet P1. Like the data packet P2, if the total data size of all data items encapsulated in any data packet has not reached the data size, i.e., the maximum data size, of the data packet, one or more data items Dn, each of which has a bit patter of all zeros, can be encapsulated in the data packet, so that the data packet becomes full.

In the sequence 3, seven dynamic data items 7(3), 8(3), 9(3), 10(3), 11(3), 12(3), and 13(3) are acquired and outputted from the recognition unit 22. Note that four static data items S7(3), S8(3), S9(3), and S10(3) are also acquired and outputted from the recognition unit 22, but, in the second area of FIG. 5, the four static data items S7(3), S8(3), S9(3), and S10(3) are not illustrated.

In the sequence 3, the seven dynamic data items 7(3), 8(3), 9(3), 10(3), 11(3), 12(3), and 13(3) are stored in the buffer 25, and the four static data items S7(3), S8(3), S9(3), and S10(3) are encapsulated in a data packet P3 following the data packet P2. Because the data packet P3 can store no more than seven data items, only three dynamic data items can be stored in the data packet P3. For this reason, the dynamic data items 7(3) to 9(3) are encapsulated in the data packet P3. The remaining four dynamic data items 10(3) to 13(3) stored in the buffer 25 are retained.

In the sequence 4, a new dynamic data item 14(4) is acquired and outputted from the recognition unit 22. Note that four static data items S11(4) to S14(4) are also acquired and outputted from the recognition unit 22, but, in the second area of FIG. 5, the four static data items S11(4) to S14(4) are not illustrated.

In the sequence 4, the new dynamic data item 14(4) is stored in the buffer 25 in which the dynamic data items 10(3) to 13(3) have remained, and the four static data items S11(4) to S14(4) are encapsulated in a data packet P4 following the data packet P3. Because the data packet P4 can store no more than seven data items, the three remaining dynamic data items 10(3) to 12(3) are encapsulated in the data packet P4. The remaining dynamic data items 13(3) and 14(4) stored in the buffer 25 are retained.

In the sequence 5, eleven dynamic data items 15(5) to 25(5) are acquired and outputted from the recognition unit 22. Note that five static data items S15(5) to S19(5) are also acquired and outputted from the recognition unit 22, but, in the second area of FIG. 5, the five static data items S15(5) to S19(5) are not illustrated.

In the sequence 5, the eleven dynamic data items 15(5) to 25(5) are stored in the buffer 25, and the five static data items S15(5) to S19(5) are encapsulated in a data packet P5 following the data packet P4. Because the data packet P5 can store no more than seven data items, only two dynamic data items can be stored in the data packet P5. For this reason, all the remaining dynamic data items 13(3) and 14(4) are encapsulated in the data packet P5. All the eleven dynamic data items 15(5) to 25(5) currently acquired in the current sequence 5 stored in the buffer 25 are retained.

Although not illustrated, the sequences 6 to 14 are carried out, so that, for example, the static data items S20 to S49 have been stored in the previous data packets P6 to P14, and six dynamic data items 24(5), 25(5), 26(6), 27(7), 28(8), and 29(9) have remained in the buffer 25.

In the sequence 15, a new dynamic data item 30(15) is acquired and outputted from the recognition unit 22. Note that six static data items S50(15) to S55(15) are also acquired and outputted from the recognition unit 22, but, in the second area of FIG. 5, the six static data items S50(15) to S55(15) are not illustrated.

In the sequence 15, the six dynamic data items 24(5), 25(5), 26(6), 27(7), 28(8), and 29(9) have remained in the buffer 25, and the new dynamic data item 30(15) is additionally stored in the buffer 25. The six static data items S50(15) to S55(15) are encapsulated in a data packet P15 following a data packet P14 (not illustrated). Because the data packet P15 can store no more than seven data items, the remaining dynamic data item 24(5) is only encapsulated in the data packet P15.

Because the storage-duration related parameter of the remaining dynamic data item 25(5), which is the absolute difference between the sequence number 5 and the currently executing sequence number 15, the storage-duration related parameter of the remaining dynamic data item 25(5), has reached the upper limit of “10”, the dynamic data item 25(5) is discarded (see step S155), and the remaining dynamic data items 26(6), 27(7), 28(8), 29(9), and 30(15) stored in the buffer 25 are retained.

In the sequence 16, a new dynamic data item 31(16) is acquired and outputted from the recognition unit 22. Note that five static data items S56(16) to S60(16) are also acquired and outputted from the recognition unit 22, but, in the second area of FIG. 5, the five static data items S56(16) to S60(16) are not illustrated.

The sequence numbers are assigned to the respective static data items and the sequence numbers are assigned to the respective dynamic data items. This enables the CPU 20 or the server apparatus 200 to easily acquire one or more of the dynamic data items, whose sequence number matches the sequence number of a selected one static data item. Similarly, this enables the CPU 20 or the server apparatus 200 to easily acquire one or more of the static data items, whose sequence number matches the sequence number of a selected one dynamic data item.

In the sequence 16, the new dynamic data item 31(16) is stored in the buffer 25 in which the dynamic data items 26(6), 27(7), 28(8), 29(9), and 30(15) have remained, and the five static data items S56(16) to S60(16) are encapsulated in a data packet P16 following the data packet P15. Because the data packet P16 can store no more than seven data items, the two remaining dynamic data items 26(6) and 27(7) are encapsulated in the data packet P16. The remaining dynamic data items 28(8), 29(9), 30(15), and 31(16) stored in the buffer 25 are retained.

As described above, the data packet generation apparatus 11 of each in-vehicle device 10 is configured to encapsulate at least one of dynamic data items included in surrounding environmental data in a data packet in response to determination that there is an available capacity in a data packet, and retain the remaining dynamic data item(s), which cannot be encapsulated in the data packet, in the buffer 25 until the storage-duration related parameter of each of the remaining dynamic data item(s) reaches the upper limit of “10”.

The illumination status of a traffic light indicated by the corresponding dynamic data items may vary rapidly. For this reason, after the in-vehicle device 10 mounted on one vehicle has acquired illumination information on a traffic light, the likelihood of the same information on the same traffic light being acquired by the in-vehicle device 10 mounted on another vehicle is low.

From this viewpoint, the data packet generation apparatus 11 of each in-vehicle device 10 is configured to encapsulate the dynamic data items in data packets as much as possible even if the encapsulation timing of the dynamic data items is delayed from the acquisition timing of the dynamic data items. This enables the server apparatus 200 to acquire as many dynamic data items as possible. In contrast, after the in-vehicle device 10 mounted on one vehicle has acquired the static data items, the likelihood of the same static data items being acquired by the in-vehicle device 10 mounted on another vehicle is high.

From this viewpoint, the data packet generation apparatus 11 of each in-vehicle device 10 is configured to discard at least one static data item, i.e., at least one remaining static data item, which cannot be encapsulated in a data packet.

The data packet generation apparatus 11 of each in-vehicle device described set forth above is configured to determine whether the available capacity of a single data packet is sufficient to encapsulate all dynamic data items included in the surrounding environmental data.

Then, the data packet generation apparatus 11 of each in-vehicle device 10 is configured to, upon determining that the available capacity of the single data packet is insufficient to encapsulate all dynamic data items included in the surrounding environmental data, encapsulate at least one remaining dynamic data item included in the surrounding environmental data, which cannot be encapsulated in the single data packet, in one or more subsequent data packets.

This configuration therefore makes it possible to avoid the occurrence of situations where dynamic data items acquired by any in-vehicle device 10 mounted on one vehicle, which change over time and are likely not to be acquired from another vehicle, are not transmitted from the in-vehicle device 10 to the server apparatus 200.

Additionally, the data packet generation apparatus 11 of each in-vehicle device 10 is configured to determine whether the available capacity of a single data packet is sufficient to encapsulate all static data items included in the surrounding environmental data. Then, the data packet generation apparatus 11 of each in-vehicle device 10 is configured to, upon determining that the available capacity of the single data packet is insufficient to encapsulate all static data items included in the surrounding environmental data, discard at least one static data item, i.e., at least one remaining static data item, which cannot be encapsulated in the single data packet.

This configuration therefore makes it possible to avoid the delay of transmission of dynamic data items to the server apparatus 200 due to static data items remaining in each single data packet. Additionally, even if such remaining static data items acquired by the in-vehicle device 10 mounted on one vehicle, which cannot be encapsulated in a single data packet, are discarded, similar static data items are likely to be acquired by the in-vehicle device 10 mounted on another vehicle. For this reason, the data packet generation apparatus 11 of each in-vehicle device 10 according to the exemplary embodiment makes it possible to reduce the impact caused by discarding static data items, as compared with discarding dynamic data items.

The data packet generation apparatus 11 of each in-vehicle device 10 includes the buffer 25. The buffer 25 is configured such that dynamic data items included in surrounding environmental data are stored therein in a predetermined order in which the dynamic data items are acquired, and the dynamic data items are retrieved in the same order in which the dynamic data items were stored therein.

In response to determination that there is at least one remaining dynamic data item, which cannot be encapsulated in a single data packet at a current data-packet generation timing, the buffer 25 is configured to retain the at least one remaining dynamic data item until one of subsequent data-packet generation timings after the current data-packet generation timing occurs. In other words, in response to determination that there is at least one remaining dynamic data item, which cannot be encapsulated in a single data packet at a current data-packet generation timing, the buffer 25 is configured to retain the at least one remaining dynamic data item until the at least one remaining dynamic data item is determined to be capable of being encapsulated in one of the data packets generated for the subsequent sequences. This therefore makes it possible to increase the likelihood of transmitting, without omission, the dynamic data items to the server apparatus 200.

The upper limit is defined for the storage-duration related parameter.

That is, the packet generator 23 of each in-vehicle device 10 is configured to determine, each time a generation timing of a data packet occurs, the available capacity of the corresponding data packet enables at least one remaining dynamic data item stored in the buffer 25 to be encapsulated therein until the storage-duration related parameter of the at least one remaining dynamic data item reaches the upper limit. Then, the packet generator 23 of each in-vehicle device 10 is configured to encapsulate, in response to determination that the available capacity of the corresponding data packet at an arbitrary generation timing enables at least one remaining dynamic data item stored in the buffer 25 to be encapsulated therein, the at least one remaining dynamic data item stored in the buffer 25 in the corresponding data packet. This therefore makes it possible to further increase the likelihood of transmitting, without omission, the dynamic data items to the server apparatus 200.

Additionally, the packet generator 23 of each in-vehicle device 10 is configured to discard at least one remaining dynamic data item stored in the buffer 25 in response to determination that the storage-duration related parameter of the at least one remaining dynamic data item reaches the upper limit at an arbitrary generation timing. This therefore makes it possible to avoid the occurrence of situations where newly acquired dynamic data items and/or static data items cannot be transmitted to the server apparatus 200 due to the long-term retention of at least one remaining dynamic data item in the buffer 25.

The storage-duration related parameter of any dynamic data item stored in the buffer 25 according to the exemplary embodiment represents the absolute difference between the sequence number of the currently executing sequence and the sequence number assigned to at least one remaining dynamic data item stored in the buffer 25.

The packet generator 23 of each in-vehicle device 10 therefore makes it possible to establish, until the sequence is executed a maximum of predetermined times, such as 10 times, both (i) retaining of the at least one remaining dynamic data item in the buffer 25 and (ii) transmitting of the at least one remaining dynamic data item when the at least one remaining dynamic data item can be transmitted in an arbitrary one of the ten sequences.

The packet generator 23 of each in-vehicle device 10 is additionally configured to discard the at least one remaining dynamic data item after the sequence is executed the predetermined times. This therefore makes it possible to prevent the available capacity of the buffer 25 from decreasing due to one or more continuously remaining dynamic data items in the buffer 25. Because the data packet generation apparatus 11 of each in-vehicle device 10 is configured to control whether to discard at least one remaining dynamic data item in the buffer 25 using the sequence number, making it possible to establish a simpler dynamic-data discarding configuration.

Because the dynamic data items include data indicative of the illumination information on at least one traffic light, it is possible to avoid unnecessary disposal of the illumination information on at least one traffic light.

### Modifications

The buffer 25 of the exemplary embodiment is configured such that dynamic data items included in surrounding environmental data are stored therein in a predetermined order in which the dynamic data items are acquired, and the dynamic data items are retrieved therefrom in the same order in which the dynamic data items were stored therein. The present disclosure is, however, not limited to the above configuration.

Specifically, the dynamic data items stored in the buffer 25 during execution of the sequence 1 are assigned with the sequence number 1, the dynamic data items stored in the buffer 25 during execution of the sequence 2 are assigned with the sequence number 2, and the dynamic data items stored in the buffer 25 during execution of the sequence 3 are assigned with the sequence number 3.

The data acquisition unit 24 can be configured to retrieve the dynamic data items stored in the buffer 25 in random order as long as the data acquisition unit 24 complies with the retrieving order of the sequence numbers from oldest, i.e., the sequence number 1, to newest, i.e., the sequence number 3.

The buffer 25 is installed in the data packet generation apparatus 11 of each in-vehicle device 10 according to the exemplary embodiment, but the buffer 25 may be installed in the corresponding in-vehicle device 10 separately from the data packet generation apparatus 11.

The data packet generation apparatus 11 of each in-vehicle device 10 is configured to discard at least one remaining dynamic data item stored in the buffer 25 in response to determination that the storage-duration related parameter of the at least one remaining dynamic data item reaches the upper limit. The present disclosure is, however, not limited to the above configuration. Specifically, each in-vehicle device 10 may be configured such that (i) no upper limit is provided for at least one remaining dynamic data item stored in the buffer 25, and (ii) the at least one remaining dynamic data item is continuously retained in the buffer 25.

The storage-duration related parameter of at least one remaining dynamic data item stored in the buffer 25 represents the absolute difference between the sequence number of the currently executing sequence and the sequence number assigned to the at least one remaining dynamic data item stored in the buffer 25. The present disclosure is, however, not limited to the above configuration. Specifically, the storage-duration related parameter of at least one remaining dynamic data item stored in the buffer 25 may be a time in, for example, milliseconds, that has elapsed since the acquisition of the at least one remaining dynamic data item. In this modification, the upper limit of one second may be set for the at least one remaining dynamic data item.

Each of the dynamic data items according to the exemplary embodiment represents the illumination information on at least one traffic light, but the present disclosure is not limited thereto.

As at least one of the dynamic data items according to the exemplary embodiment, any type of information, which is (i) usable for generating the three-dimensional map data and/or for driving assistance and is (ii) changeable over time, may be used in place of or in addition to the illumination information on at least one traffic light. For example, information, which represents (i) the display state of electronic signboards placed on roadsides or (ii) the presence or absence of pylons in construction zones, may be used as at least one of the dynamic data items.

The acquisition of surrounding environmental data by the data acquisition unit 24, the storage of dynamic data items included in the surrounding environmental data by the data acquisition unit 24 in the buffer 25, and the generation of a data packet by the packet generator 23 are for example executed every 100 milliseconds as a synchronized sequence. The present disclosure is, however, not limited thereto.

Specifically, the generation of a data packet by the packet generator 23 may be executed only after the surrounding environmental data whose size is no more than 900 bytes is acquired by the data acquisition unit 24. This modification makes it possible to eliminate the need of encapsulating one or more data items Dn in the remaining available space of the data packet.

The data packet generation apparatuses 11 and their data packet generation methods disclosed in the present disclosure can be implemented by a dedicated computer including a memory and a processor programmed to perform one or more functions embodied by one or more computer programs.

The data packet generation apparatuses 11 and their data packet generation methods disclosed in the present disclosure disclosed in the present disclosure can also be implemented by a dedicated computer including a processor comprised of one or more dedicated hardware logic circuits.

The data packet generation apparatuses 11 and their data packet generation methods disclosed in the present disclosure can further be implemented by a processor system comprised of a memory, a processor programmed to perform one or more functions embodied by one or more computer programs, and one or more hardware logic circuits.

The one or more programs can be stored in a computer-readable non-transitory storage medium as instructions to be carried out by a computer or a processor.

The present disclosure can be implemented in various forms. For example, the present disclosure may be embodied as object detection methods, object detection apparatuses, computer program instructions for implementing each object detection method, and/or non-transitory storage media, each of which stores the computer program instructions.

The present disclosure is not limited to the above exemplary embodiment and its modifications, and can be implemented by various configurations within the scope of the present disclosure. For example, technical features included in the exemplary embodiment and its modifications, which correspond to technical features included in the exemplary aspect described in the SUMMARY of the present disclosure, can be freely combined with each other or can be freely replaced with another feature in order to solve a part or all of the above issue and/or achieve a part or all of the above advantageous benefits. One or more of the technical features included in the above exemplary embodiment and its modifications, which are not described as essential elements in the specification, can be omitted as necessity arises.

The present disclosure can be implemented as methods of controlling a collision mitigation function, computer program instructions for implementing each of the methods, and/or non-transitory storage media, each of which stores the computer program instructions.

The present disclosure can be grasped as the following technological aspects:

### [First Technological Aspect]

A data packet generation apparatus (11) for a vehicle according to the first technological aspect includes a data acquisition unit (24) configured to acquire, in each of sequences, surrounding environmental data recognized based on one or more measurements from at least one sensor (60) installed in the vehicle. The surrounding environmental data represents a surrounding environment around the vehicle. The surrounding environmental data acquired in each sequence includes at least one of one or more dynamic data items that are changeable over time, and one or more static data items that do not change over time.

The data packet generation apparatus includes a packet generator (23) configured to generate, for each sequence, a data packet based on at least the surrounding environmental data acquired in the corresponding sequence. The data packet has a predetermined data size.

The packet generator is configured to determine, for each sequence, whether all the one or more dynamic data items included in the surrounding environmental data acquired in the corresponding sequence can be encapsulated in the corresponding data packet, and encapsulate, in response to determination that at least one dynamic data item included in the surrounding environmental data acquired in the corresponding sequence cannot be encapsulated in the corresponding data packet as at least one remaining dynamic data item, the at least one remaining dynamic data item in one of the data packets generated for the subsequent sequences.

Additionally, the packet generator is configured to determine, for each sequence, whether all the one or more static data items included in the surrounding environmental data acquired in the corresponding sequence can be encapsulated in the corresponding data packet, and discard, in response to determination that at least one static data item included in the surrounding environmental data acquired in the corresponding sequence cannot be encapsulated in the corresponding data packet as at least one remaining static data item, the at least one remaining static data item.

### [Second Technological Aspect]

In the data packet generation of the second technological accept, which depends from the first technological accept, the packet generator is configured to encapsulate, in response to determination that all the one or more dynamic data items included in the surrounding environmental data acquired in the corresponding sequence can be encapsulated in the corresponding data packet, all the one or more dynamic data items in the corresponding data packet. The packet generator is configured to encapsulate, in response to determination that all the one or more static data items included in the surrounding environmental data acquired in the corresponding sequence can be encapsulated in the corresponding data packet, all the one or more static data items in the corresponding data packet.

### [Third Technological Aspect]

The data packet generation of the third technological accept, which depends from the first technological accept, further includes a buffer (25) configured such that the one or more dynamic data items included in the surrounding environmental data acquired in each sequence are stored therein and are retrieved therefrom. The buffer is configured to retain, in response to determination that the at least one remaining dynamic data item occurs in each sequence, the at least one remaining dynamic data item therein until the at least one remaining dynamic data item is determined to be capable of being encapsulated in one of the data packets generated for the subsequent sequences.

### [Fourth Technological Aspect]

In the data packet generation of the fourth technological accept, which depends from the third technological accept, the buffer is configured such that the one or more dynamic data items included in the surrounding environmental data acquired in each sequence are stored therein in a predetermined order and are retrieved therefrom in the same predetermined order.

### [Fifth Technological Aspect]

In the data packet generation of the fifth technological accept, which depends from the third technological accept, any dynamic data item stored in the buffer is defined as an in-buffer dynamic data item. The data acquisition unit is configured to determine whether there is at least one in-buffer dynamic data item stored in the buffer, a storage-duration related parameter of the at least one in-buffer dynamic data item has reached a predetermined upper limit. The storage-duration related parameter of each in-buffer dynamic data item stored in the buffer represents a parameter related to a duration for which the corresponding in-buffer dynamic data item has been stored in the buffer.

When the at least one remaining dynamic data item occurs in a selected sequence in the sequences, the packet generator is configured to determine, at a data-packet generation timing of each of the subsequent sequences after the selected sequence, whether an available capacity of the data packet of the corresponding one of the subsequent sequences enables the at least one remaining dynamic data item stored in the buffer to be encapsulated therein until the storage-duration related parameter of the at least one remaining dynamic data item reaches the upper limit. The packet generator is configured to encapsulate, in response to determination that the available capacity of the data packet at one of the subsequent sequences enables the at least one remaining dynamic data item stored in the buffer to be encapsulated therein until the storage-duration related parameter of the at least one remaining dynamic data item reaches the upper limit, the at least one remaining dynamic data item in the data packet of the one of the subsequent sequences. The packet generator is configured to discard, in response to determination that the storage-duration related parameter of the at least one remaining dynamic data item reaches the upper limit while the at least one remaining dynamic data item stored in the buffer is determined not to be capable of being encapsulated in the data packet of each of the subsequent sequences, the at least one remaining dynamic data item stored in the buffer.

### [Sixth Technological Aspect]

In the data packet generation of the sixth technological accept, which depends from the fifth technological accept, each of the sequences is configured as a synchronized sequence including (i) acquisition of the corresponding surrounding environmental data by the data acquisition unit, (ii) storage of the corresponding one or more dynamic data items included in the corresponding surrounding environmental data by the data acquisition unit in the buffer, and (iii) generation of the corresponding data packet by the packet generation unit, the sequences being executed every predetermined period. The data acquisition unit is configured to store the one or more dynamic data items included in the surrounding environmental data of each sequence in the buffer while assigning a sequence number of the corresponding sequence to each of the one or more dynamic data items. The storage-duration related parameter of each of the in-buffer dynamic data items stored in the buffer represents an absolute difference between a sequence number of a currently executing sequence included in the sequences and the sequence number assigned to the corresponding one of the in-buffer dynamic data items.

### [Seventh Technological Aspect]

In the data packet generation of the seventh technological accept, which depends from the first technological accept, each of the one or more dynamic data items included in the surrounding environmental data acquired in each sequence includes data indicative of illumination information on at least one traffic light (Sg1).

### [Eighth Technological Aspect]

A data packet generation method for a vehicle according to the eighth technological aspect includes acquiring (S105), in each of sequences, surrounding environmental data recognized based on one or more measurements from at least one sensor (60) installed in the vehicle. The surrounding environmental data represents a surrounding environment around the vehicle. The surrounding environmental data acquired in each sequence includes at least one of one or more dynamic data items that are changeable over time, and one or more static data items that do not change over time.

The data packet generation method includes generating (S120 to S145), for each sequence, a data packet based on at least the surrounding environmental data acquired in the corresponding sequence. The data packet has a predetermined data size.

The generating includes determining (S130), for each sequence, whether all the one or more dynamic data items included in the surrounding environmental data acquired in the corresponding sequence can be encapsulated in the corresponding data packet, and encapsulating (S140, S140), in response to determination that at least one dynamic data item included in the surrounding environmental data acquired in the corresponding sequence cannot be encapsulated in the corresponding data packet as at least one remaining dynamic data item, the at least one remaining dynamic data item in one of the data packets generated for the subsequent sequences. The generating includes determining (S115), for each sequence, whether all the one or more static data items included in the surrounding environmental data acquired in the corresponding sequence can be encapsulated in the corresponding data packet, and discarding (S120), in response to determination that at least one static data item included in the surrounding environmental data acquired in the corresponding sequence cannot be encapsulated in the corresponding data packet as at least one remaining static data item, the at least one remaining static data item.

### [Ninth Technological Aspect]

A program product of data packet generation for a vehicle according to the ninth technological accept includes a non-transitory storage medium (30), and program instructions stored in the non-transitory storage medium. The program instructions cause a processor (20) to acquire, in each of sequences, surrounding environmental data recognized based on one or more measurements from at least one sensor installed in the vehicle. The surrounding environmental data represents surrounding environment around the vehicle. The surrounding environmental data acquired in each sequence includes at least one of one or more dynamic data items that are changeable over time, and one or more static data items that do not change over time. The program instructions cause the processor to generate, for each sequence, a data packet based on at least the surrounding environmental data acquired in the corresponding sequence, the data packet having a predetermined data size. The program instructions cause the processor to determine, for each sequence, whether all the one or more dynamic data items included in the surrounding environmental data acquired in the corresponding sequence can be encapsulated in the corresponding data packet, and encapsulate, in response to determination that at least one dynamic data item included in the surrounding environmental data acquired in the corresponding sequence cannot be encapsulated in the corresponding data packet as at least one remaining dynamic data item, the at least one remaining dynamic data item in one of the data packets generated for the subsequent sequences. The program instructions cause the processor to determine, for each sequence, whether all the one or more static data items included in the surrounding environmental data acquired in the corresponding sequence can be encapsulated in the corresponding data packet, and discard, in response to determination that at least one static data item included in the surrounding environmental data acquired in the corresponding sequence cannot be encapsulated in the corresponding data packet as at least one remaining static data item, the at least one remaining static data item.

1. A data packet generation apparatus for a vehicle, the data packet generation apparatus comprising:
a data acquisition unit configured to acquire, in each of sequences, surrounding environmental data recognized based on one or more measurements from at least one sensor installed in the vehicle, the surrounding environmental data representing a surrounding environment around the vehicle,
the surrounding environmental data acquired in each sequence including at least one of:
one or more dynamic data items that are changeable over time; and
one or more static data items that do not change over time; and
a packet generator configured to generate, for each sequence, a data packet based on at least the surrounding environmental data acquired in the corresponding sequence, the data packet having a predetermined data size,
the packet generator being configured to:
determine, for each sequence, whether all the one or more dynamic data items included in the surrounding environmental data acquired in the corresponding sequence can be encapsulated in the corresponding data packet;
encapsulate, in response to determination that at least one dynamic data item included in the surrounding environmental data acquired in the corresponding sequence cannot be encapsulated in the corresponding data packet as at least one remaining dynamic data item, the at least one remaining dynamic data item in one of the data packets generated for the subsequent sequences;
determine, for each sequence, whether all the one or more static data items included in the surrounding environmental data acquired in the corresponding sequence can be encapsulated in the corresponding data packet; and
discard, in response to determination that at least one static data item included in the surrounding environmental data acquired in the corresponding sequence cannot be encapsulated in the corresponding data packet as at least one remaining static data item, the at least one remaining static data item.

2. The data packet generation apparatus according to claim 1, wherein:
the packet generator is configured to:
encapsulate, in response to determination that all the one or more dynamic data items included in the surrounding environmental data acquired in the corresponding sequence can be encapsulated in the corresponding data packet, all the one or more dynamic data items in the corresponding data packet; and
encapsulate, in response to determination that all the one or more static data items included in the surrounding environmental data acquired in the corresponding sequence can be encapsulated in the corresponding data packet, all the one or more static data items in the corresponding data packet.

3. The data packet generation apparatus according to claim 1, further comprising:
a buffer configured such that the one or more dynamic data items included in the surrounding environmental data acquired in each sequence are stored therein and are retrieved therefrom,
wherein:
the buffer is configured to retain, in response to determination that the at least one remaining dynamic data item occurs in each sequence, the at least one remaining dynamic data item therein until the at least one remaining dynamic data item is determined to be capable of being encapsulated in one of the data packets generated for the subsequent sequences.

4. The data packet generation apparatus according to claim 3, wherein:
the buffer is configured such that the one or more dynamic data items included in the surrounding environmental data acquired in each sequence are stored therein in a predetermined order and are retrieved therefrom in the same predetermined order.

5. The data packet generation apparatus according to claim 3 wherein:
any dynamic data item stored in the buffer is defined as an in-buffer dynamic data item;
the data acquisition unit is configured to determine whether there is at least one in-buffer dynamic data item stored in the buffer, a storage-duration related parameter of the at least one in-buffer dynamic data item having reached a predetermined upper limit, the storage-duration related parameter of each in-buffer dynamic data item stored in the buffer representing a parameter related to a duration for which the corresponding in-buffer dynamic data item has been stored in the buffer; and
when the at least one remaining dynamic data item occurs in a selected sequence in the sequences, the packet generator is configured to:
determine, at a data-packet generation timing of each of the subsequent sequences after the selected sequence, whether an available capacity of the data packet of the corresponding one of the subsequent sequences enables the at least one remaining dynamic data item stored in the buffer to be encapsulated therein until the storage-duration related parameter of the at least one remaining dynamic data item reaches the upper limit;
encapsulate, in response to determination that the available capacity of the data packet at one of the subsequent sequences enables the at least one remaining dynamic data item stored in the buffer to be encapsulated therein until the storage-duration related parameter of the at least one remaining dynamic data item reaches the upper limit, the at least one remaining dynamic data item in the data packet of the one of the subsequent sequences; and
discard, in response to determination that the storage-duration related parameter of the at least one remaining dynamic data item reaches the upper limit while the at least one remaining dynamic data item stored in the buffer is determined not to be capable of being encapsulated in the data packet of each of the subsequent sequences, the at least one remaining dynamic data item stored in the buffer.

6. The data packet generation apparatus according to claim 5 wherein:
each of the sequences is configured as a synchronized sequence including (i) acquisition of the corresponding surrounding environmental data by the data acquisition unit, (ii) storage of the corresponding one or more dynamic data items included in the corresponding surrounding environmental data by the data acquisition unit in the buffer, and (iii) generation of the corresponding data packet by the packet generation unit, the sequences being executed every predetermined period;
the data acquisition unit is configured to store the one or more dynamic data items included in the surrounding environmental data of each sequence in the buffer while assigning a sequence number of the corresponding sequence to each of the one or more dynamic data items; and
the storage-duration related parameter of each of the in-buffer dynamic data items stored in the buffer represents an absolute difference between a sequence number of a currently executing sequence included in the sequences and the sequence number assigned to the corresponding one of the in-buffer dynamic data items.

7. The data packet generation apparatus according to claim 1 wherein:
each of the one or more dynamic data items included in the surrounding environmental data acquired in each sequence includes data indicative of illumination information on at least one traffic light.

8. A data packet generation method for a vehicle, the data packet generation method comprising:
acquiring, in each of sequences, surrounding environmental data recognized based on one or more measurements from at least one sensor installed in the vehicle, the surrounding environmental data representing a surrounding environment around the vehicle,
the surrounding environmental data acquired in each sequence including at least one of:
one or more dynamic data items that are changeable over time; and
one or more static data items that do not change over time; and
generating, for each sequence, a data packet based on at least the surrounding environmental data acquired in the corresponding sequence, the data packet having a predetermined data size,
the generating including:
determining, for each sequence, whether all the one or more dynamic data items included in the surrounding environmental data acquired in the corresponding sequence can be encapsulated in the corresponding data packet;
encapsulating, in response to determination that at least one dynamic data item included in the surrounding environmental data acquired in the corresponding sequence cannot be encapsulated in the corresponding data packet as at least one remaining dynamic data item, the at least one remaining dynamic data item in one of the data packets generated for the subsequent sequences;
determining, for each sequence, whether all the one or more static data items included in the surrounding environmental data acquired in the corresponding sequence can be encapsulated in the corresponding data packet; and
discarding, in response to determination that at least one static data item included in the surrounding environmental data acquired in the corresponding sequence cannot be encapsulated in the corresponding data packet as at least one remaining static data item, the at least one remaining static data item.

9. A program product of data packet generation for a vehicle, the program product comprising:
a non-transitory storage medium; and
program instructions stored in the non-transitory storage medium,
the program instructions causing a processor to:
acquire, in each of sequences, surrounding environmental data recognized based on one or more measurements from at least one sensor installed in the vehicle, the surrounding environmental data representing a surrounding environment around the vehicle,
the surrounding environmental data acquired in each sequence including at least one of:
one or more dynamic data items that are changeable over time; and
one or more static data items that do not change over time; and
generate, for each sequence, a data packet based on at least the surrounding environmental data acquired in the corresponding sequence, the data packet having a predetermined data size,
the program instructions causing the processor to:
determine, for each sequence, whether all the one or more dynamic data items included in the surrounding environmental data acquired in the corresponding sequence can be encapsulated in the corresponding data packet;
encapsulate, in response to determination that at least one dynamic data item included in the surrounding environmental data acquired in the corresponding sequence cannot be encapsulated in the corresponding data packet as at least one remaining dynamic data item, the at least one remaining dynamic data item in one of the data packets generated for the subsequent sequences;
determine, for each sequence, whether all the one or more static data items included in the surrounding environmental data acquired in the corresponding sequence can be encapsulated in the corresponding data packet; and
discard, in response to determination that at least one static data item included in the surrounding environmental data acquired in the corresponding sequence cannot be encapsulated in the corresponding data packet as at least one remaining static data item, the at least one remaining static data item.
